(19) United States
(12) Patent Application Publication
(10) Pub. No.: US 2020/0383456 A1
(43) Pub. Date: Dec. 10, 2020

(54) SKIN-CARE ACCESSORIES

(71) Applicants: Rachel Henderson, Manhattan Beach, CA (US); Ashley Magovern, Manhattan Beach, CA (US)

(72) Inventors: Rachel Henderson, Manhattan Beach, CA (US); Ashley Magovern, Manhattan Beach, CA (US)

(21) Appl. No.: 16/858,565

(22) Filed: Apr. 24, 2020

Related U.S. Application Data
(60) Provisional application No. 62/838,209, filed on Apr. 24, 2019.

(51) Int. Cl. A45D 40/00; A61Q 17/04; B65D 81/36

(52) U.S. Cl. CPC A45D 40/00; A61Q 17/04; A45D 2200/05; A45D 2040/0012; A45D 2040/0006; B65D 81/366

(57) ABSTRACT

Provided herein are embodiments of a skin-care accessory. The skin-care accessory may include a head portion; a neck portion; a body portion; a dispensing portion, wherein the dispensing portion is attached to the head portion; a cap topper, wherein the cap topper further comprises an attachment mechanism; and a fluid component. The fluid component may include zinc oxide ranging between 1% to 20% by weight of the fluid component. The fluid component may also disperse out of the skin-care accessory through the dispensing portion.

### CROSS-REFERENCE TO RELATED APPLICATIONS

This application claims priority pursuant to 35 U.S.C. § 119(e) to U.S. Provisional Patent Application No. 62/838,209, filed Apr. 24, 2019, the disclosure of which is hereby incorporated by reference in its entirety.

### FIELD

Embodiments of the present invention relate to skin-care accessories, and more specifically to skin-care accessories and a cap topper.

### BACKGROUND

Skin is our body's largest organ. It serves as a protective barrier between our insides and the rest of the world, helps regulate body temperature, and acts as a filter. Skin exists in a constant state of growth with old cells dying as new cells are forming. It is affected by every aspect of our lives from what we eat to where we live to how we take care of it. Healthy skin is better able to fight signs of aging, heals much faster, and staves off potential disease better than unhealthy skin.

Proper skin care is vital. Unhealthy skin tends to appear sallow and dull, whereas healthy skin appears full and vibrant. Wrinkles develop with more ease and sink deeper if our skin is dehydrated and unhealthy, and it can result in uneven patches that have a mottled color. When skin is unhealthy it loses elasticity, which can make it sag and appear thin.

However, proper skin care is not only about looking good, it's about staying healthy. Poor skin care habits can lead to rashes, sores, acne and wrinkles. Unhealthy skin is more susceptible to disease, infection, and is more likely to scar after an injury. Proper care is particularly important for people who experience skin issues, such as psoriasis, or have skin allergies.

However, proper skin care is not just limited to moisturizing. Especially in this day and age, skin damage to the sun's rays is a serious issue. UVA rays are present throughout the day and penetrate past the skin's epidermis and into its dermis layer. These rays are what make the skin produce melanin (aka what makes us tan) but they also contribute to skin cancer and cause fine lines and wrinkles. This is because UVA rays damage collagen in the dermis layer, and collagen is what makes the skin plump and youthful. UVB rays, which are strongest between 10 AM and 4 PM in the U.S., only reach the epidermis. But they damage the surface of the skin, cause sunburn, and play a role in the development of skin cancer.

Skin cancer is one of the most common forms of cancer in the U.S. (and also in many other countries in the world)—in the last 30 years, more people have had skin cancer than all other cancers combined. According to the Skin Cancer Foundation, 90% of non-melanoma skin cancers are a result of UV radiation from the sun. Skin cancer is a result of uncontrolled growth of abnormal skin cells. This growth begins when UV radiation causes damage to the DNA within our skin cells.

One of the ways to protect our skin is through the regular use of sunscreens. Sunscreens have a far more significant long-term impact on skin quality than all other skincare products combined. Sunscreens protect our skin from the most common source of skin problems: Overexposure to UV light. By protecting the skin from long-term skin damage, sunscreens can be said to be the most powerful anti-aging product.

However, in order to be effective, the sunscreen needs to be applied in adequate quantity and regularly. Although sunscreens are generally inexpensive relative to other cosmetic products like creams and lotions, the cost and ease of use can still be a burden and a factor that discourages regular sunscreen use. For example, the spray-on sunscreen disperses unequally and enters the nose, eyes, and mouth of the users and those around them. Further, the sunscreens that come in a tube and need to be rubbed in are uncomfortable to use. Further, many of these available sunscreens have undesirable textures, e.g., they are sticky, and often leave a residual “goo” on our hands because of excess use. Further, many available sunscreens are not suitable for a broad range of skin types. In fact, while adults may still remember and want to use the sunscreens despite the limitations of the existing sunscreens, children often do not. Even when children do use the available sunscreens, they often create a mess and usually need adult supervision to apply the sunscreens.

Accordingly, there is a need for skin-care accessories, such as sunscreens, that are easy to use, have desirable textures, can be used evenly, and/or be suitable for the skin of all types and people of all ages. Further, there is a need for skin-care accessories, such as sunscreens, that are also easy and fun to use for persons of all ages, e.g., by being easy to carry, hold, tuck away into backpacks, and/or pockets, etc. There is also a need for skin-care accessories, such as sunscreens, that contain other minerals, vitamins, and nutrients, such as antioxidants and anti-inflammatories, that are good for the skin.

### SUMMARY

Provided herein are embodiments of a skin-care accessory. The skin-care accessory may include a head portion; a neck portion; a body portion; a dispensing portion, wherein the dispensing portion is attached to the head portion; a cap portion, wherein the cap portion further comprises an attachment mechanism; and a fluid component. The fluid component may include sunscreen having a clean-ingredient formula which may include 100% mineral active ingredients. In some embodiments, the sunscreen may include naturally derived zinc oxide and titanium dioxide. In some embodiments, zinc oxide may range between 1% to 20% by weight of the fluid component. The fluid component may also disperse out of the skin-care accessory through the dispensing portion.

Although embodiments of the present disclosure are referred to as skin-care accessory, it may be used for other non-skin care products or containers.

Other features and advantages of the present invention are or will become apparent to one skilled in the art upon examination of the following figures and detailed description, which illustrate, by way of examples, the principles of the present invention.

The systems, methods, and apparatuses described herein in detail for skin-care accessories and sunscreen are example embodiments and should not be considered limiting. Other configurations, methods, features and advantages of the subject matter described herein will be or will become apparent to one with skill in the art upon examination of the following figures and detailed description. It is intended that all such additional configurations, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a timeline of sunscreen evolution leading to some embodiments of the present invention.

FIG. 2 illustrates a front view of skin-care accessories, according to exemplary embodiments of the present invention.

FIG. 3 illustrates a front view of skin-care accessories in a display, according to exemplary embodiments of the present invention.

FIG. 4A illustrates a side view of skin-care accessories in a display, according to exemplary embodiments of the present invention.

FIG. 4B illustrates a front view of skin-care accessories in another display, according to exemplary embodiments of the present invention.

FIG. 4C illustrates a front view of skin-care accessories in a clip strip display, according to exemplary embodiments of the present invention.

FIGS. 5A, 5B, and 5C illustrate various stages of a user using skin-care accessories, according to exemplary embodiments of the present invention.

FIG. 6 illustrate users carrying skin-care accessories, according to exemplary embodiments of the present invention.

FIG. 7 illustrates a front view of a skin-care accessory with a first animal shape, according to exemplary embodiments of the present invention.

FIG. 8 illustrates a front view of a skin-care accessory with a second animal shape, according to exemplary embodiments of the present invention.

FIG. 9 illustrates a front view of a skin-care accessory with a third animal shape, according to exemplary embodiments of the present invention.

FIG. 10 illustrates a front view of a skin-care accessory with a fourth animal shape, according to exemplary embodiments of the present invention.

FIG. 11A illustrates a front view of a skin-care accessory with a fifth animal shape, according to exemplary embodiments of the present invention.

FIG. 11B illustrates a side view of a skin-care accessory with the fifth animal shape, according to exemplary embodiments of the present invention.

FIG. 11C illustrates a back view of a skin-care accessory with the fifth animal shape, according to exemplary embodiments of the present invention.

FIG. 12A illustrates a front view of a skin-care accessory with a sixth animal shape, according to exemplary embodiments of the present invention.

FIG. 12B illustrates a side view of a skin-care accessory with the sixth animal shape, according to exemplary embodiments of the present invention.

FIG. 12C illustrates a back view of a skin-care accessory with the sixth animal shape, according to exemplary embodiments of the present invention.

FIG. 13A illustrates a front view of a skin-care accessory with a seventh animal shape, according to exemplary embodiments of the present invention.

FIG. 13B illustrates a side view of a skin-care accessory with the seventh animal shape, according to exemplary embodiments of the present invention.

FIG. 13C illustrates a back view of a skin-care accessory with the seventh animal shape, according to exemplary embodiments of the present invention.

FIG. 14A illustrates a front view of a skin-care accessory with an eighth animal shape, according to exemplary embodiments of the present invention.

FIG. 14B illustrates a side view of a skin-care accessory with the eighth animal shape, according to exemplary embodiments of the present invention.

FIG. 14C illustrates a back view of a skin-care accessory with the eighth animal shape, according to exemplary embodiments of the present invention.

FIG. 15A illustrates a front view of a cap portion of a skin-care accessory, according to exemplary embodiments of the present invention.

FIG. 15B illustrates a bottom perspective view of a cap portion of a skin-care accessory, according to exemplary embodiments of the present invention.

FIG. 15C illustrates another bottom perspective view of a cap portion of a skin-care accessory, according to exemplary embodiments of the present invention.

FIG. 15D illustrates an exemplary cap topper attached to a skin-care accessory, according to exemplary embodiments of the present invention

FIG. 16 illustrates an ingredient list of an exemplary fluid component, according to exemplary embodiments of the present invention.

### DETAILED DESCRIPTION

The below described figures illustrate the described invention and method of use in at least one of its preferred, best mode embodiments, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

While the apparatus, methods, and systems described herein are described for sunscreens, they may be used in any other skin-care accessory, such as moisturizers, lip balms, lotions, sanitizers, soaps, massage oils, etc.

Skin-Care Accessories

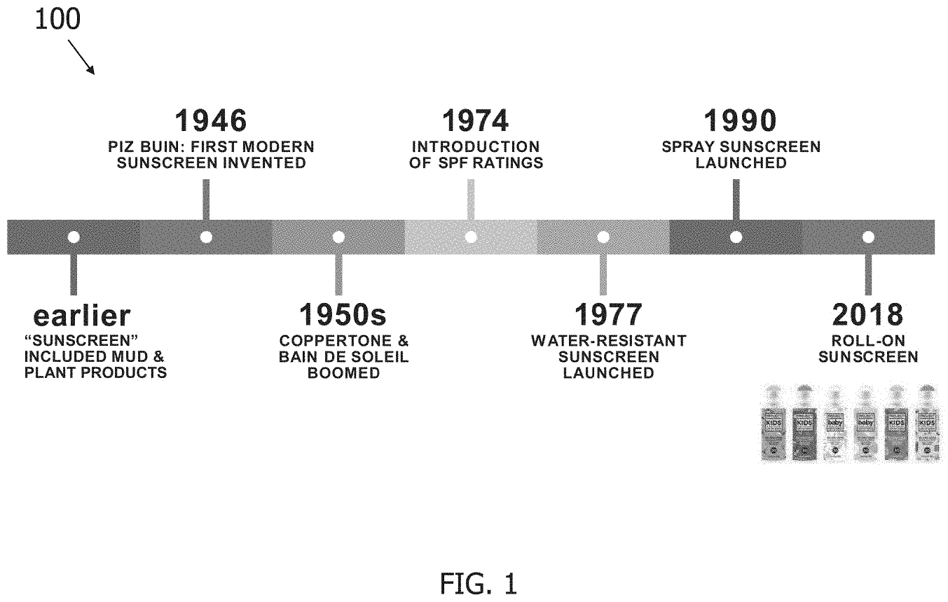

Turning to the figures, FIG. 1 illustrates a timeline 100. As illustrated in the timeline, in early times, “sunscreens” were essentially natural products, such as mud, plants, etc. that users applied on their body. Eventually in 1946, the first version of the modern sunscreen by Piz Buin was developed. Then in the 1950s, companies, such as Coppertone and Bain de Soleil boomed. Eventually in 1974, the sunscreens began to have SPF ratings. The SPF ratings, in some cases, were divided by skin color and the number of hours spent in the sun. In 1977, the first water-resistant sunscreen was launched. In 1990, sunscreens that were capable of being sprayed on were launched. Finally, in 2018, embodiments of the present invention were launched.

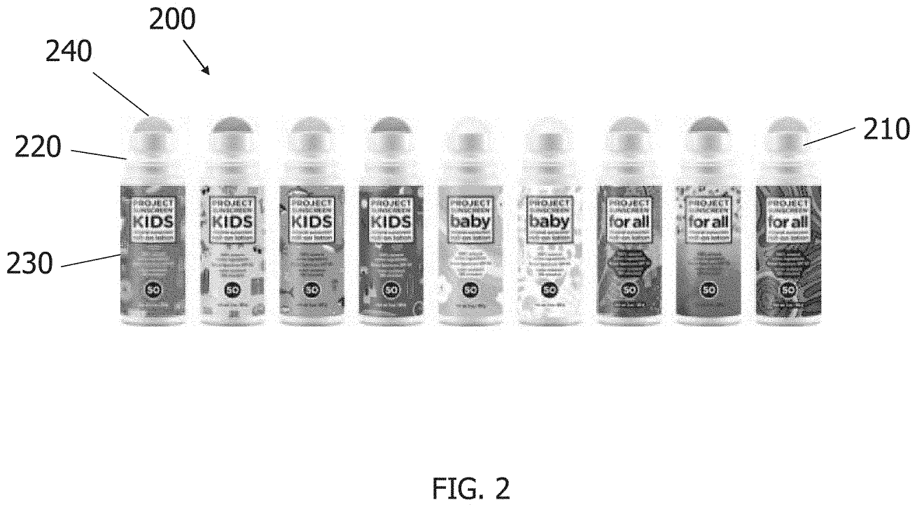

FIG. 2 illustrates skin-care accessories 200. In some embodiments, the skin-care accessory 200 may include a head portion 210, a neck portion, 220, and a body portion 230. It may also include a dispensing portion 240. In this example, the dispensing portion 240 is shown as a roll-on, however other types of dispensing are also possible, e.g., a pump. The head portion 210 may have an opening that facilitates at least a portion of the dispensing portion 240 to be attached to it. The dispensing portion 240 (e.g., a roll-on) may be of any size, shape, such as semi-spherical, triangular, or any arbitrary shape and/or color. The roll-on portion 240 may be capable of moving in any direction while within the head portion 210. In some embodiments, as illustrated in FIG. 2, the roll-on portion 240 may be substantially spherical, such as a roller ball. The neck portion 220 may also be of any shape, size and/or color. It may or may not have one half of an attachment mechanism, such as grooves, that facilitate its engagement with another half of the attachment mechanism located elsewhere, such as on a cap portion. The body portion may be of any shape, size, and color. In some embodiments, as illustrated in FIG. 2, the body portion 230 may be substantially cylindrical. The body portion 230 may include design features, such as stickers, labels etc., that may be of various colors, shapes, and sizes. The design features may also provide information regarding the name of the company, the SPF ratings, the fluid component in the skin-care accessories 200, such as sunscreens, lotions, soaps, etc.

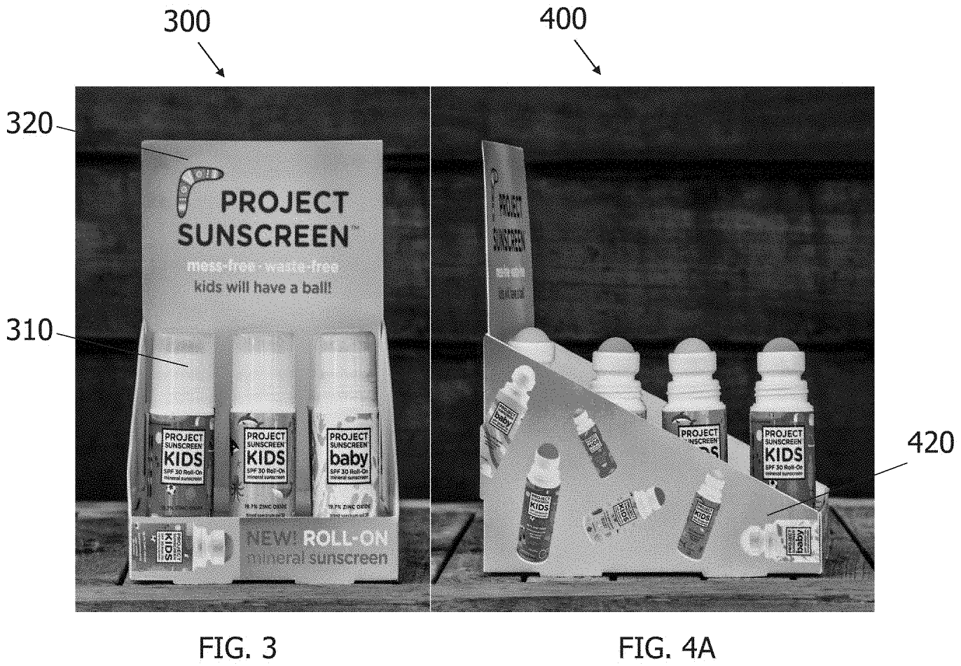

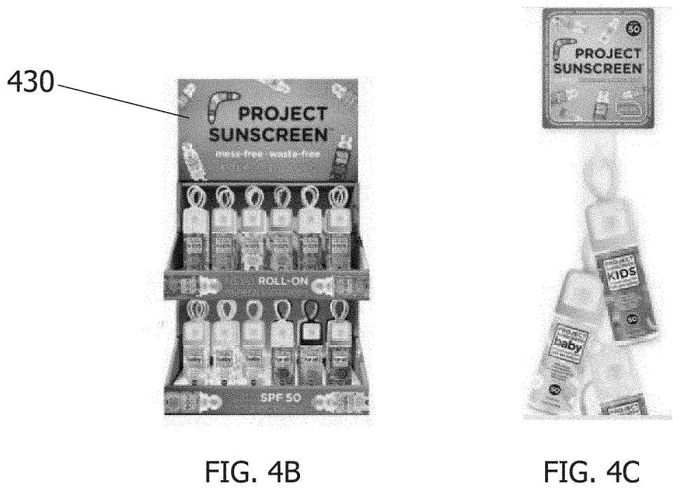

FIGS. 3 and 4 illustrate skin-care accessories 300 and 400, according to some embodiments of the present invention. The skin-care accessories 300 and 400 may be available in packs with a few skin-care accessories or be available as individual pieces. In some embodiments, as illustrated in FIG. 3, the skin-care accessories may have a cap portion 310. The cap portion 310 may be of any shape, size, and color. In some embodiments, the cap portion 310 may have one half of an attachment mechanism that corresponds to the other half of the attachment mechanism that may be located on the head, neck, or body portion of the skin-care accessories 300. The attachment mechanism may include any means that allow attaching the cap portion 310 with the head, neck, and/or body portion of the skin-care accessories, such as snaps, grooves, adhesives, magnets, hooks, loops with clips, buttons, etc. The cap portion 310 may completely or partially cover the dispensing portion. i.e., in some embodiments, the dispensing portion may only be accessed by the complete or partial removal of the cap portion 310. In other embodiments, the dispensing portion may be accessed by simply changing the orientation of the cap portion 310.

In some embodiments, as illustrated in FIG. 3, the cap portion 310 may be substantially cylindrical and may be semi-transparent. In some embodiments, as illustrated in FIG. 3, the skin-care accessories 300 may be displayed in a displayed 320. The display 320 may allow the individual skin-care accessories pieces to be displayed side-by-side when viewed from the front. In some embodiments, as illustrated in FIGS. 4A and 4B, the skin-care accessories 400 may be displayed in a displayed 420 and 430. The displays 420 and 430 may allow the individual skin-care accessories pieces to be displayed one in front (or back) of another when viewed from the front. FIG. 4C illustrates a display 440 with clip strip for displaying the individual skin-care accessories pieces.

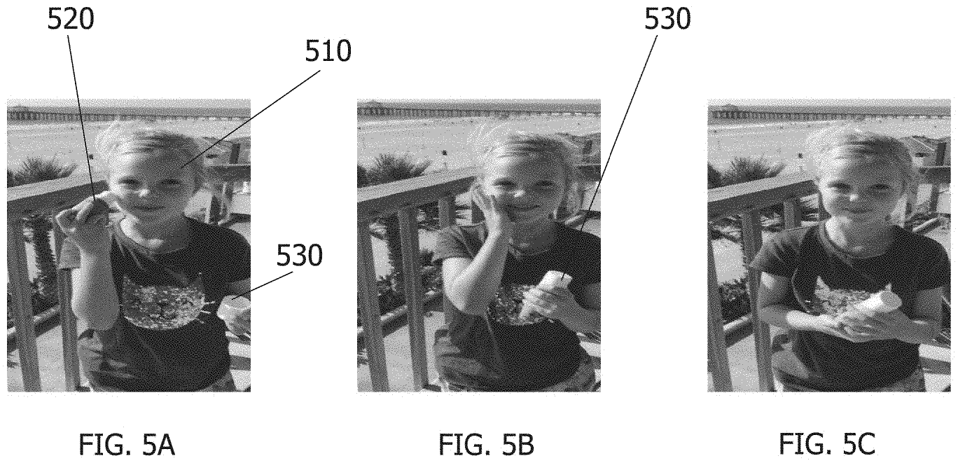

FIGS. 5A-5C illustrate a user 510 using a skin-care accessory 520. As illustrated, in some embodiments, the dispensing portion on the skin-care accessory 520 may be of any shape that facilitates the user being able to conveniently move over their skin. In some embodiments, that dispensing portion may be spherical, e.g. as a roll-on. The roll-on portion may be capable of moving in any direction. For example, if the user 510 moves the roll-on portion of the skin-care accessory 520 on their face, as illustrated in FIG. 5A, the roll-on portion needs not be operated in just one direction and may in fact be capable of a 360-degree movement. In some embodiments, the user 510 may have to apply pressure to the body portion of the skin-care accessory 520 to dispense the fluid component of the skin care accessory 520. Applying such a pressure may facilitate the constituents to move within the body portion of the skin-care accessory 510 and coat at least a section of the roll-on portion. Subsequently, when the user 510 moves the roll-on portion on their skin, the constituents may get transferred to the skin of the user. In other embodiments, other principles, such as gravity, may be sufficient to dispense the constituents towards the roll-on portion. As illustrated, the cap portion 530 may be opaque.

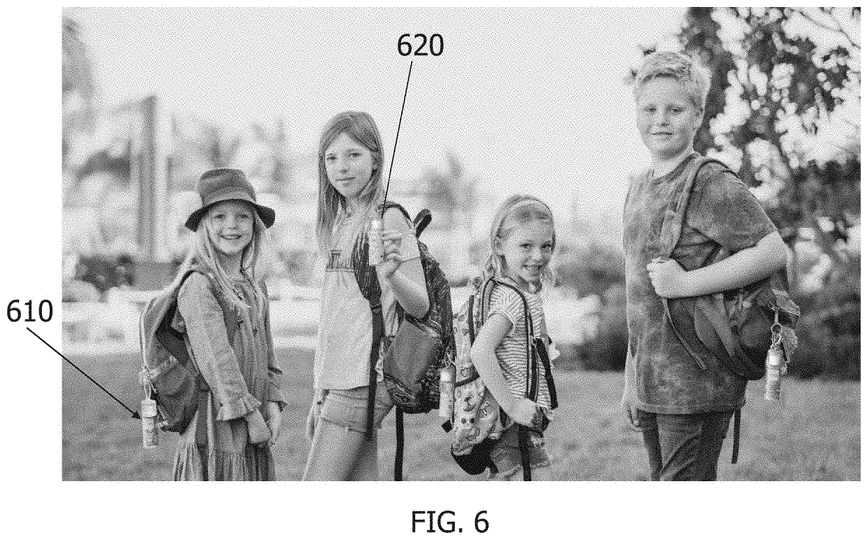

FIG. 6 illustrates users carrying a skin-care accessory 610, according to some embodiments of the present invention. As illustrated, the cap portion 620 may be transparent or translucent or at least a portion of the cap portion may be transparent or translucent while the other is opaque. The cap portion 620 may also have an attachment mechanism, as described herein, that facilitates the attachment of the dispensing portion to other items, such as bags, beach totes, gym and other bags, belts, strollers, etc. For example, as illustrated, the attachment mechanism may be an open loop, e.g., a hook shape. The attachment mechanisms described herein may be detachable and/or be located in any portion, including the cap portion 620, body portion, neck portion, head portion, etc., of the skin-care accessory 610. The attachment mechanism may be attached to the cap portion 620 in a way that the body portion may be able to be detached while the cap portion 620 is still attached to the underlying item (e.g., a backpack). In some, embodiments, the loop may have an opening on one end that facilities convenient insertion onto a backpack or other items. In other embodiments, the attachment mechanism may in itself have other attachments mechanisms that facilitate various portions of the attachment mechanisms to be connected together. For example, the loop may have a snap-on/snap-off portion that could be snapped on to hook it on to the backpack and then snapped back closed.

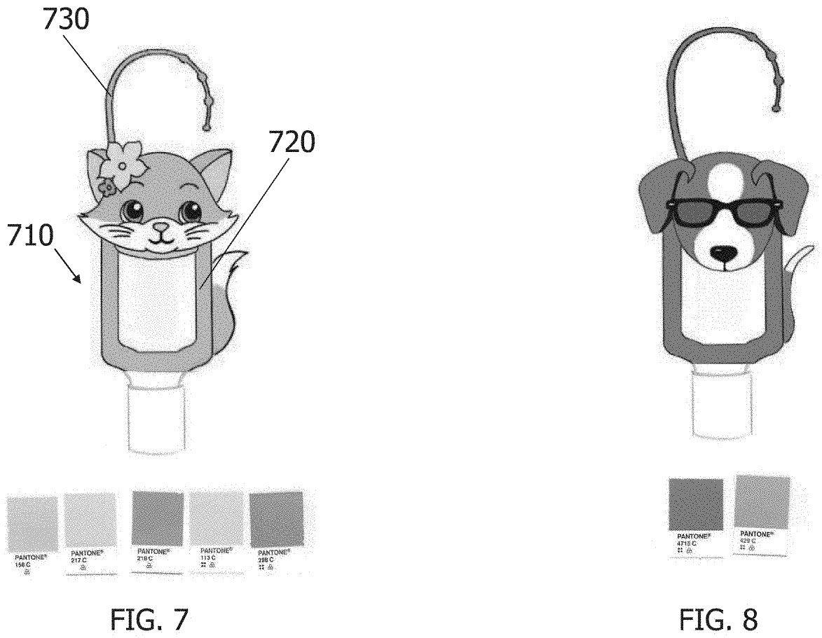

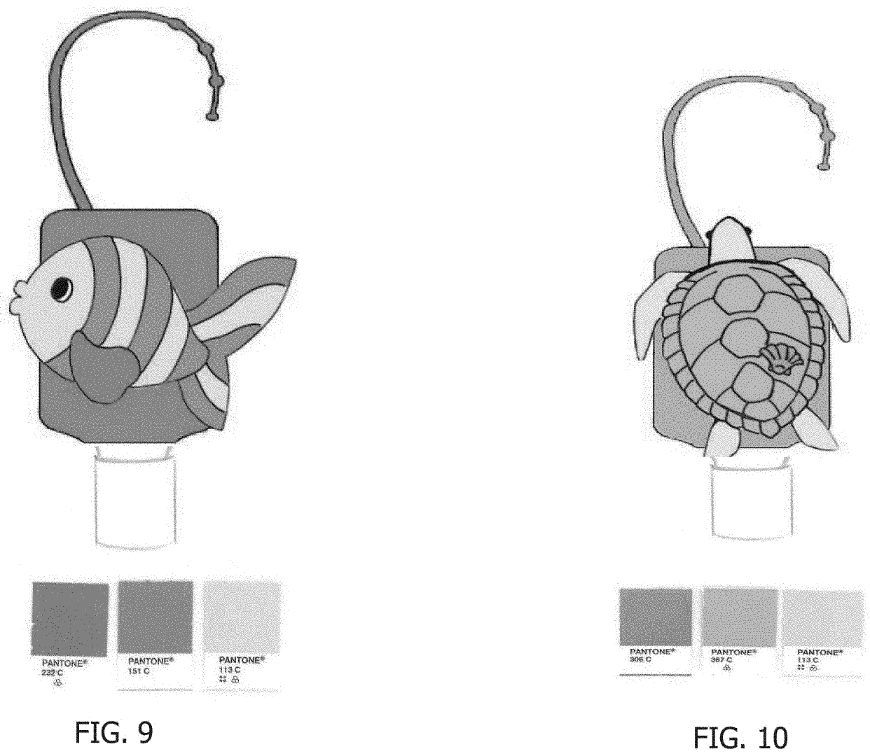

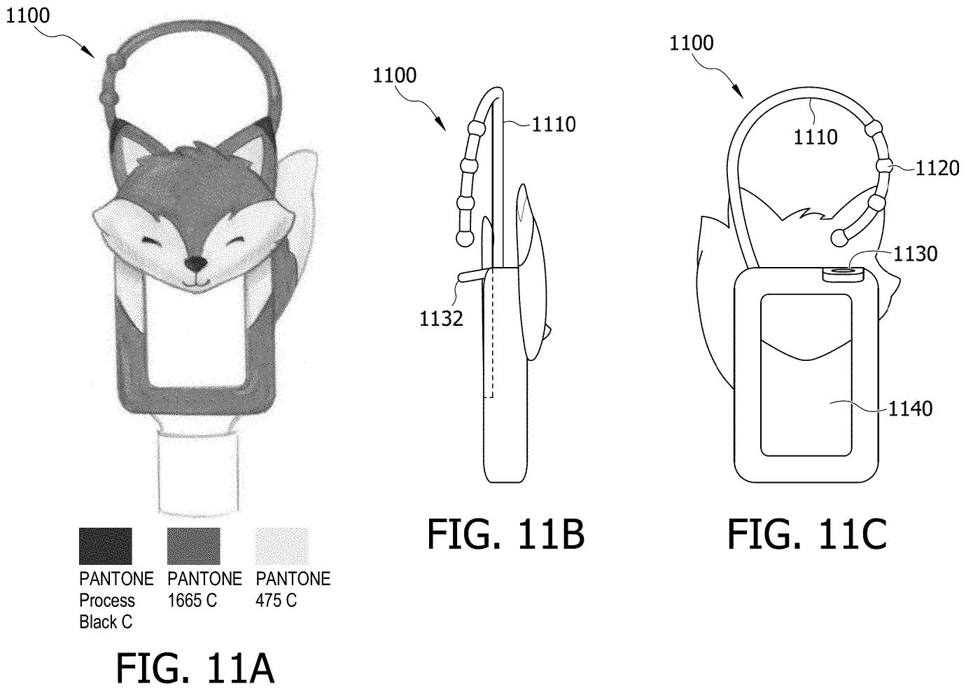

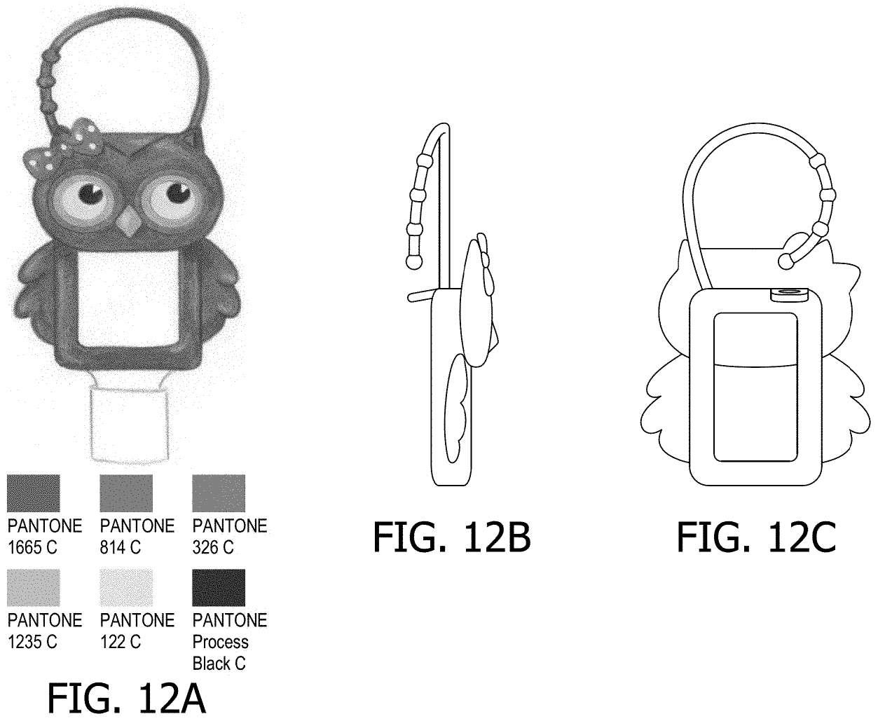

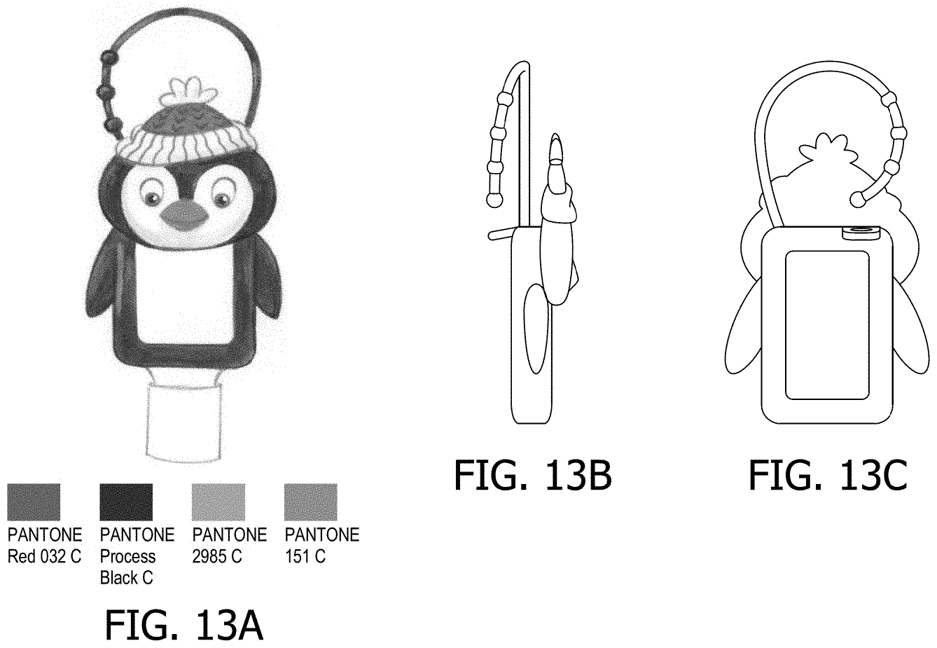

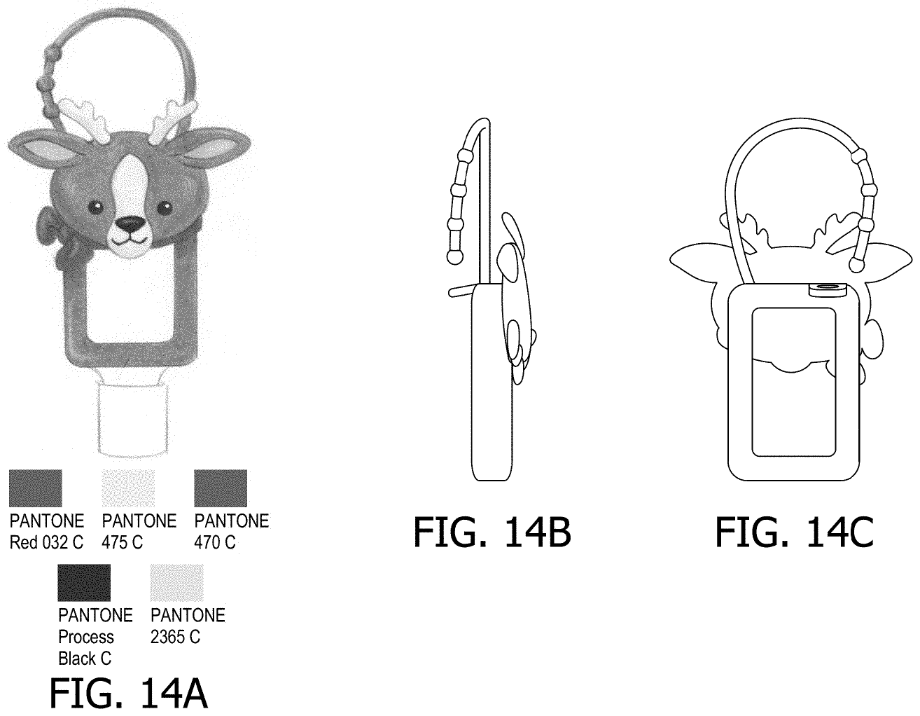

As illustrated in FIGS. 7 through 14, there may be different designs on the skin-care accessory. For example, as illustrated in FIG. 7, for the skin-care accessory 710 the design element may be animal shapes 720 on the body portion and/or neck portion. The animal shapes may be seasonally designed or be random. For example, the animal shapes may be cats (as illustrated in FIG. 7.), dogs (as illustrated in FIG. 8), fishes (as illustrated in FIG. 9), turtles (as illustrated in FIG. 10), foxes (as illustrated in FIG. 11), owls (as illustrated in FIG. 12), penguins (as illustrated in FIG. 13), reindeers (as illustrated in FIG. 14), etc. The animal shapes 720 may be of any color. In some embodiments, the animal shapes 720 may be detachable from the corresponding portions of the skin-care accessory 710. There may be an attachment mechanism 730, as described in FIG. 6, located on the body portion of the skin-care accessory 710. The attachment mechanism 730 may also be located on the animal shape 720. FIGS. 7-10, 11A, 12A, 13A, and 14A show the skin-care accessory fit over the body portion of a container (e.g., bottle) from the bottom.

In another example, as illustrated in FIG. 11C, the attachment mechanism 1110 may have beads 1120. In some embodiments, the beads may facilitate the skin-care accessory 1100 to be securely fastened to another item by inserting the beads into a corresponding opening 1130 located on the skin-care accessory 1100. In some embodiments, the opening 1130 may be sized slightly smaller than the size of the beads 1120, such that after inserting the beads 1120 into the opening 1130, the attachment mechanism 1110 may not detach from the portion of the skin-care accessory 1110 via the opening 1130 without an intervention or action from a user, for example, by pulling or detaching the attachment mechanism 1110 out of the opening 1130.

As illustrated in FIG. 11B showing a side view of the skin-care accessory 1100, in some embodiments, the corresponding opening 1130 may be located in a receiver portion (or receiver) 1132 fixedly attached to the skin-care accessory 1100. In these embodiments, after inserting the beads 1120 into the opening 1130 in the receiver portion 1132, the attachment mechanism 1110 may not detach from the receiver portion 1132 of the skin-care accessory 1110 via the opening 1130 without an intervention or action from a user, for example, by pulling or detaching the attachment mechanism 1110 out of the opening 1130.

It should be noted that although the beads are shown having a rounded edge (e.g., a circle), they may also have other shape, e.g., triangle, square, etc.

As illustrated in FIG. 11C, the skin-care accessory 1110 may include an opening 1140.

The colors of any portions of the skin-care accessory and/or animal shapes described herein may be done using the available options at Pantone® or any other company. For example, the colors may be one or a combination of Pantone® 156 C, 217 C, 218 C, 113 C, 298 C, 4715 C, 429 C, 232 C, 151 C, 306 C, 367 C, Progress Black C, 1665 C, 475 C, 814 C, 326 C, 1235 C, 122 C, Red 032 C, 2985 C, 470C, 2635 C, etc.

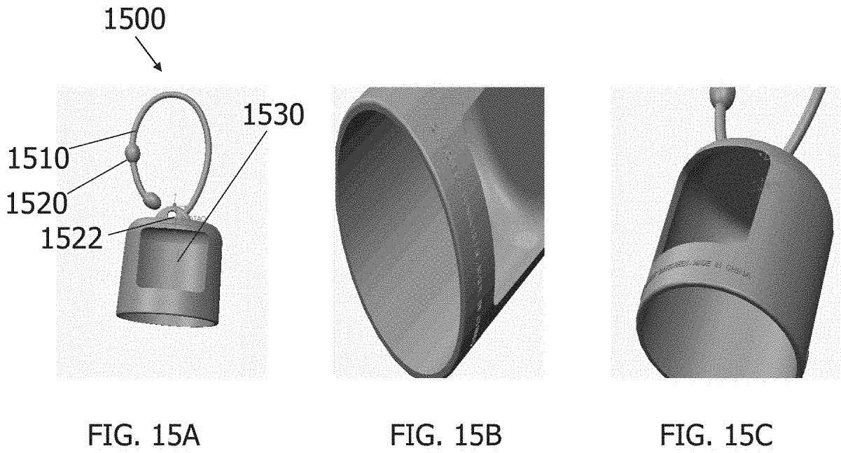

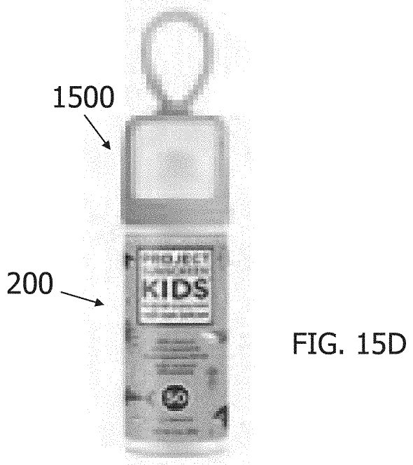

FIGS. 15A, 15B and 15C illustrate an exemplary cap topper or skin-care accessory 1500. In some embodiments, the cap topper 1500 may fit over the cap portion of a container, e.g., a skin-care bottle. In some embodiments, the cap topper 1500 may fit over other types of bottle with or without its own cap attached.

In some embodiments, the cap topper 1500 may have an attachment mechanism 1510, as described herein, e.g., having a hook shape loop, attached using the attachment mechanism 1510 with beads 1520 inserting into an opening of a receiver portion (or receiver) 1522, which is fixedly attached to the top portion of the cap topper 1500 or manufactured as a single piece together with the cap topper 1500. In these embodiments, after inserting the beads 1520 into an opening in the receiver portion 1522, the attachment mechanism 1510 is securely attached to the receiver portion 1522, e.g., the attachment mechanism 1510 may not detach from the receiver portion 1522 via the opening without an intervention or action from a user, for example, by pulling or detaching the attachment mechanism 1510 out of the opening.

In some embodiments, the cap topper 1500 may either be completely closed off or it may have an opening 1530 in at least a portion of it. In some embodiments where the cap topper 1500 includes the opening 1530, the opening 1530 may be closed off with a transparent or semi-transparent cover.

In some embodiments, the cap topper 1500 may include an animal shape (e.g., as shown in FIGS. 7-14A), or any other design.

FIG. 15D illustrates an exemplary cap topper 1500 attached to a skin-care accessory 200 of the present disclosure.

The cap topper, skin-care accessories and the various portions thereof of the present disclosure may be made of any material, such as silicon, fabric, strings, leather, metal, plastic, etc.; have any size, be of any shape, such as circular/spherical, cuboidal, oval, dome-like, pyramidal, a combination of one or more shape, or just be asymmetrical in shape.

In some embodiments, different portions of the cap topper may be made of different materials. For example, the body portion of the cap topper may be made of silicone and the attachment mechanism may be made of metal.

Sunscreen

As described herein, in some embodiments, the skin-care accessories described herein may contain sunscreen inside their body portion. The sunscreen may include a clean-ingredient formula which may include 100% mineral active ingredients. The sunscreen is at least reef and ocean friendly. In some embodiments, the sunscreen may include naturally derived zinc oxide and titanium dioxide. In other embodiments, the sunscreen may include approximately 18% zinc oxide. In other embodiments, the sunscreen may include more or less zinc oxide. The sunscreen may also include other elements, such as antioxidants, moisturizing vitamin B3, sooth anti-inflammatory, licorice and/or tea extracts. The sunscreen may also include conventionally available materials that are already used in sunscreens in it. In some embodiments, it may not include nanoparticles that potentially clog the skin's pores, are allergenic, and are damaging to the users' DNA. It may also not include oxybenzone that potentially causes hormone disrupting and coral bleaching in reefs. It may also not include any parabens, which is potentially cancer causing and hormone disrupting.

The sunscreen may be fragrance-free, dye-free, gluten-free, and/or be non-GMO. The sunscreen may provide a broad range of SPF, such as SPF 30 broad spectrum with UVA/UVB protection. It may also be water-resistant up to 80 minutes (less or more is also contemplated).

In some embodiments, the sunscreen may roll on as white and may run into the skin and become clear. The sunscreen may be mess-free, i.e., it may be quick-drying and have a lightweight formula; it may not leave the users' hands or other body parts sticky; it may have adequate mechanism in place to prevent the caps from leaking; etc. The sunscreen may also be waste-free, i.e., upon usage, there may not be any leftover or white residue left on the user's skin. The user may be able to apply the sunscreen quickly.

The final viscosity of the sunscreen may be such that it coats the dispensing portion of the skin-care accessory as described herein and is adequately dispersed on the skin of the users. In some embodiments, the viscosity may be such that a good mineral zinc oxide content and/or other elements of the sunscreen are actively dispersed through the dispensing portion onto the skin of the user. In some embodiments, the viscosity of the sunscreen may range from 7500-75000 cps. In other embodiments, the viscosity may be more or less. However, excessive viscosity means that the sunscreen may not disperse adequately on the dispensing portion and thus subsequently on the skin of the user and inadequate viscosity would result in the sunscreen leaking from the sides of the dispensing portion and the neck portion of the skin-care accessory.

It should be noted that the formulas described above are not meant to be limited. Other ingredients, variations, and combinations are also possible.

In order to develop an embodiment of the sunscreen that may possess the advantageous features described herein, tests were conducted. In one of the tests, the objective was to measure the SPF value for a sunscreen formula following 80-minutes water immersion and the Static SPF value of the FDA standard sunscreen product using FDA, 21 CFR Sec. 201.327, subpart (i), SPF Test Procedure, Sunscreen Drug Products for Over-the-Counter Human Use, Final Monograph, Federal Register, Vol. 76, No. 117, Jun. 17, 2011. It was hoped that the SPF value would be 40. In the test, thirteen (13) users were subject to an 80-minute water-resistant SPF study. The sample sunscreen that was used had a tentative SPF value of 50 and Formula # 3301-5A, FSTI Sample # 18-820. The Above Rinaldi Labs, Inc. sample labeled Formula # 3301-5A, was assigned to Florida Suncare Testing, Inc. with a sample number 18-820 and entered into the SPF test submission log. The FDA standard 15 SPF sunscreen, as described in FDA, 21 CFR, Sec. 201.327, subpart (i) (2), SPF Standard, was used concomitantly as the control test product for this test.

The test sample included fair-skinned subjects, male and female, eighteen years of age or older, of skin types I, II, or III as defined in FDA, 21 CFR, Sec. 201.327, subpart (i), SPF Test Procedure, (3) Test Subjects, (ii) Medical History, (B) Skin Type, Jun. 17, 2011. The thirteen subjects ranged in age from nineteen to sixty. There were five males and eight females that comprised the thirteen subjects. Nine of the subjects had type 1 skin type and four had type 2 skin type. Type I skin type is one that always burns easily and never tans, i.e., sensitive skin. Type II skin type is one that always burns easily and tans minimally, i.e., also sensitive skin. Type III skin type is one that burns moderately and tans gradually, i.e., normal skin type.

The test subjects were selected based on the following criteria: a) Inclusion Criteria: 1) Individuals eighteen years of age or older. 2) Individuals with fair, uniformly-colored skin on the lower area of the back which would allow a discernable erythema. 3) Individuals free of any dermatological or systemic disorder which, in the opinion of the testing personnel, would interfere with the results of the study. 4) Individuals in good health who had completed a preliminary medical history. 5) Individuals who had read, understood, and signed a consent document in compliance with 21 CFR 50.; b) Exclusion Criteria: 1) Individuals with any visible skin disease at the study site, which in the opinion of the investigative personnel would, interfere with the study results. 2) Individuals taking medications which might affect study results, e.g., photosensitizers, antihistamines, analgesics, or anti-inflammatory drugs. 3) Females who were pregnant, planning a pregnancy or nursing a child. 4) Individuals with a history of skin cancer. 5) Individuals with a history of hepatitis or other blood disease. 6) Individuals with a known sensitivity to cosmetics, skin-care products or topical drugs as related to product(s) being evaluated. 7) Individuals with recent sun exposure on the areas to be tested.

An informed consent was signed by each test subject prior to initiating the test describing the purpose of the test, the test procedure, potential risks and benefits of participating, as well as the limits of liability. Each test subject completed an extensive medical history form and was assigned a subject identification number.

A Xenon Arc Solar Simulator lamp, which has a continuous light spectrum in the UVA and UVB range (290-400 nanometers) was utilized. The spectral output of the solar simulator was filtered so that it meets the spectral output requirements for testing Sunscreen Drug Products for over-the-counter human use; FDA Final Monograph, 21 CFR Part 201.327 (i)(1), UV Source, Federal Register, Vol. 76, No. 117, Jun. 17, 2011 and the International Sun Protection Factor (SPF) Test Method, May 2006.

During the test, on day one, the test subjects reported to the testing laboratory and received a complete explanation of the test procedures. Those who participated signed a written, witnessed consent form, and a permission to release personal health information form and provided a brief medical history. The technician did a final examination of the test subject's back, between the belt-line and shoulder blades and determined their suitability to participate in the test. Further, a series of 5 UV radiation doses, expressed as Joules/square meter, increasing in 25% increments, was administered to two unprotected separate locations on the test subject's back, just below the shoulder blades and above the belt-line, to determine the initial unprotected Minimal Erythemal Dose (MEDu). The test subjects were instructed to avoid additional UV exposure, and to avoid taking any photosensitizing medications until the conclusion of the study. The MEDu was administered in the following 5 dose series, Dose 1=0.64×, Dose=0.80×, Dose 3=1.00×, Dose 4=1.25×, and Dose 5=1.53×, with X representing the amount of UV energy projected to produce the test subject's MEDu.

One day two, the test subjects returned to the testing laboratory within 16 to 24 hours following completion of the MEDu doses for evaluation of their responses, and to determine each test subject's unprotected MEDu The test subject's MEDu was the quantity of erythema effective energy, or dose corresponding to the first site that produced the first unambiguous erythema reaction with clearly defined borders.

In the test, two test areas (10 cm×5 cm), 50 square centimeter rectangles, were drawn in the designated locations on the test subject's back, (between the beltline and the shoulder blade) using a template and an indelible marker. The technician applied the test formula in one of the test areas and the FDA standard sunscreen in the adjacent test area. The sunscreens were applied by “spotting” the product across the test area and gently spreading, using a finger cot (as specified in FDA, 21 CFR 201.327, subpart (4)(iii), until a uniform film was applied to the entire test area. A product density of 2 mg/cm² was delivered to the test area. To accomplish this, the technician weighed an amount in excess of 100 mg to allow for the residual amount left on the finger cot (approximately 10 percent). The test products were permitted to dry a minimum of 15 minutes prior to the static UV exposures on the standard sunscreen and the 80-minute water immersion of the test formula.

An indoor fresh water Jacuzzi maintained at 23 to 32 deg. Celsius was used in this testing procedure. Fresh water is clean drinking water that meets the standards in 40 CFR part 141. The pool and air temperature, as well as the relative humidity was recorded prior to testing. The SPF values for the test product submitted by the sponsor was determined after 80 minutes of water immersion using the following procedure as specified in FDA, 21 CFR 201.237, subpart (i) (7) (ii), Determination of Water Resistance: a) apply sunscreen product followed by a minimum 15-minute waiting period after application; b) twenty minutes of moderate activity in the water; c) fifteen-minute rest period; d) repeat steps b. and c. until a total of 80 minutes of water immersion is achieved; and e) conclude the water test. The test sites were air dried completely without toweling. A light source exposure to the 80-minute water resistant test site areas in accordance with FDA, 21 CFR 201.327, subpart (5), UV Exposure was then begun.

The technician administered a series of 5 UV radiation doses expressed as Joules/square meter, as specified in FDA, 21 CFR, Sec. 201.327, subpart (5)(iii), progressively increasing in increments of 15 or 20 percent, determined by the previously established MEDu (unprotected MED) from Day 1 and the expected SPF range of the test product. The MEDp was administered in a 5-dose series.

On Day 2, the technician administered a second timed series of 5 UV doses, increasing in 25 percent increments to an unprotected area of the subject's back to determine the subject's second day MEDu The series of 5 doses included the original MEDu from Day 1 in the center as follows: 1) Subjects returned 16 to 24 hours following completion of the UV doses from Day 2. The MED for all sites that received UV doses, both protected and unprotected areas was evaluated. 2) The study was conducted in a double-blinded manner. Neither the test subjects nor the designated staff member who evaluated the MED responses knew which sunscreen formulation was applied to which site or what doses of UV radiation were administered, as he was not the technician who applied the sunscreen test products or administered the doses of UV radiation. 3) The grader evaluated and recorded the MED responses on both the unprotected and protected test sites under the following conditions: a) the source of illumination was a warm white fluorescent light bulb that provides a level of illumination of at least 450 lux at the test site. b) the test subject was seated when evaluated, the same as when the test sites were irradiated.

SPF values were calculated for both the test product and the FDA standard using FDA, 21 CFR 201.327, subpart (i) (6), Determination of SPF, by calculating the ratio of the MEDp value produced in the sunscreen protected sites to the MEDu produced in the unprotected test area, for each individual using the following calculation: MEDp/MEDu=SPF value.

Data from ten subjects was used for calculating the test product's label SPF value. The mean SPF value (x) and the Standard Deviation (s) for these subjects was computed. Based on a full ten-subject test panel, the upper 5-percent point from the student distribution table (denoted by t) with n−1 degrees of freedom was obtained. The quantity A was computed using the formula A=ts/Square root n (with n representing the number of test subjects (10) in a full study). A label SPF value was calculated by determining the largest whole number less than X−A. Any test product with a label SPF less than 2 is not a sunscreen drug product and will not display an SPF value.

There were three primary reasons for rejection of study data as noted in 21 CFR, Sec. 201.327, subpart (5)(v), Invalid Test Data. The exposure series fails to elicit a MED response on either the protected or unprotected test sites; an MED response was noted on all the protected test sites, or the test subject was non-compliant (failed to follow instructions or withdrew from the study).

A total of thirteen healthy subjects who fulfilled the test panel participation criteria were inducted into this investigation. The individual, mean, and label SPF values of the Above Rinaldi Labs, Inc. test product, SPF 50 Tentative, Formula # 3301-5A, FSTI Sample # 18-820 is incorporated by reference in its entirety. No adverse experiences were reported during this study.

In conclusion, the SPF of the above sample described herein; tested under 80-minute “Water Resistant” conditions, yielded the following SPF values: Sponsor Formula Number: 3301-5A; FTSI Sample Number 18-820; Mean 80 min WR SPF=52.87; and Label SPF=50. The FDA standard for this study had a mean static SPF value of 17 .14 and satisfied all statistical criteria as specified in FDA, 21 CFR, Sec. 201.327, subpart (6)(i).

It should be noted that the above test is an example and is not meant to limit the types and number of tests performed.

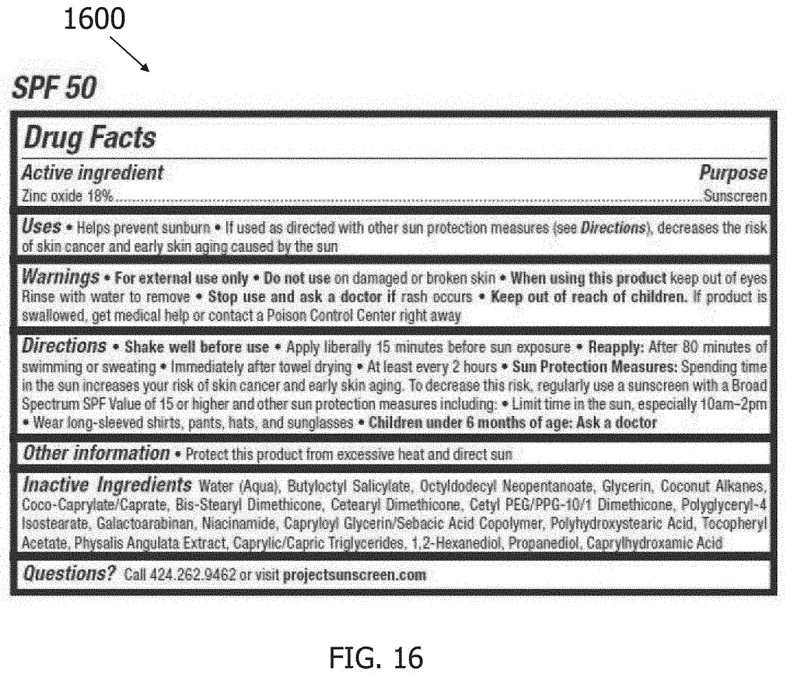

FIG. 16 illustrates an ingredient list 1600 of an exemplary fluid component. The ingredient list 1600 corresponds to a sunscreen with a SPF value of 50. The ingredient list may include both active ingredients and inactive ingredients. The active ingredients may just include zinc oxide as illustrated in FIG. 16. In some embodiments, the active ingredients in a sunscreen with SPF 50 may be zinc oxide 18% by weight of the fluid component. The zinc oxide may also be of any other percentage by weight of the fluid component. Other active ingredients may also be included in the sunscreen. In other embodiments, the active ingredients and inactive ingredients may be completely different depending on the fluid component. In some embodiments, as illustrated, the ingredient list 1600 may also include the uses, warnings, directions for use, other information, and questions. according to exemplary embodiments of the present invention.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

1. A skin-care accessory comprising:
a head portion;
a neck portion connected to the head portion;
a body portion connected to the neck portion;
a dispensing portion, wherein the dispensing portion is attached to the head portion; and
a cap topper, wherein the cap topper further comprises an attachment mechanism having a hook shape and a receiver portion.

2. The skin-care accessory of claim 1, wherein the attachment mechanism further comprises one or more beads having a first size.

3. The skin-care accessory of claim 2, wherein the receiver portion further comprises an opening having a second size to receive the one or more beads.

4. The skin-care accessory of claim 3, wherein the second size is slightly smaller than the first size such that when the attachment mechanism is inserted into the opening, the attachment mechanism is securely attached to the receiver portion.

5. The skin-care accessory of claim 1, wherein the dispensing portion is within the head portion.

6. The skin-care accessory of claim 5, wherein the dispensing portion may move in any direction while being within the head portion.

7. The skin-care accessory of claim 1, wherein the neck portion further comprises grooves that facilitate the neck portion's engagement with the cap topper.

8. A cap topper for container, the cap topper comprising:
a body portion comprising an attachment mechanism having a hook shape and a receiver portion.

9. The cap topper of claim 8, wherein the attachment mechanism further comprises one or more beads having a first size.

10. The cap topper of claim 8, wherein the receiver portion further comprises an opening having a second size to receive the one or more beads.

11. The cap topper of claim 10, wherein the second size is slightly smaller than the first size such that when the attachment mechanism is inserted into the opening, the attachment mechanism is securely attached to the receiver portion.

12. A sunscreen comprises:
18% zinc oxide;
one or more antioxidants;
moisturizing vitamin B3;
sooth anti-inflammatory; and
licorice and/or tea extracts.

13. The sunscreen of claim 12, wherein the sunscreen is further non-clogging.

14. The sunscreen of claim 12, wherein the sunscreen is further non-allergic.

15. The sunscreen of claim 12, wherein the sunscreen is further non-hormone disrupting and non-coral bleaching.

16. The sunscreen of claim 12, wherein the sunscreen further has a viscosity between 7500 and 75000 cps.

17. The sunscreen of claim 12, wherein the sunscreen is further gluten-free and/or non-GMO.
